(19) United States
(12) Patent Application Publication
(10) Pub. No.: US 2006/0130324 A1
(43) Pub. Date: Jun. 22, 2006

(54) Method for fine machining cylindrical inner surfaces

(76) Inventors: Ulrich Haerer, Rudersberg-Lindental (DE); Franz Rueckert, Ostfildern (DE); Helmut Schaefer, Kernen (DE); Peter Stocker, Sulzbach (DE); Oliver Storz, Altbach (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/509,758

(22) PCT Filed: Mar. 12, 2003
(86) PCT No.: PCT/EP03/02525

§ 371 Date: Jun. 22, 2005

(30) Foreign Application Priority Data
Mar. 30, 2002 (DE) 102 14 374.9

(51) Int. Cl. B23P 15/00

(52) U.S. Cl. 29/888.06

(57) ABSTRACT

The invention relates to a method for fine machining a cylindrical inner surface which has materials of different hardnesses in the axial direction, and comprises the following steps: pre-turning of the surface, with at least one softer area of the surface being pre-turned to a greater diameter than a harder area, honing of at least the harder area down to the diameter level of the softer area.

### BACKGROUND AND SUMMARY OF THE INVENTION

The invention relates to a method for fine machining a cylindrical inner surface, in particular, a cylinder running surface, which has materials of different hardnesses in the axial direction.

The fine machining of cylindrical surfaces, in particular the fine machining of cylindrical running surfaces of cylinder crankcases, is generally realized by honing. There are many publications relating to this, such as for example DE 44 32 514 A1, in which a method by which a highly accurate final dimension of a honed surface can be achieved is described.

DE 196 05 588 C2 describes a method in which a cylinder running surface is treated at a top and bottom dead center of the piston in such a way that it withstands conditions of greater wear in these areas.

The known prior art is restricted however to the fine machining of a surface which has the same surface material throughout. However, it may be the case that the cylinder running surface is represented by different materials. This takes the form of a softer area, which is formed by the cast material of the cylinder crankcase, and a harder area, which is represented by a cylinder liner.

In cases of this kind, fine machining, in particular honing, is particularly difficult, since the machining means used, for example the honing stone, becomes smeared by the softer material and loses its abrasive effect.

The object of the invention is to fine machine cylindrical inner surfaces which have different materials in such a way that the useful lives of the machining means are significantly improved.

A method provides the solution for achieving the object of the invention, which method comprises the following steps: pre-turning of the cylindrical inner surface, with at least one softer area of the cylindrical inner surface being pre-turned to a great diameter than at least one harder area, and honing of at least the harder area down to the diameter level of the softer area.

The method according to the invention is distinguished in that a cylindrical inner surface which has at least one softer area and at least one harder area in the axial direction is firstly pre-turned. The pre-turning may in this case possibly comprise a number of working steps with a number of turning tools and turning parameters such as the feed rate or rotational speeds. It may also include what is known as fine turning.

The at least one softer area is in this case pre-turned to a greater diameter. This is followed by the fine machining by honing. The honing takes place in the harder area. The honing is stopped by a suitable control at the diameter to which the softer area has been pre-turned. This spares the honing stone. Increased smearing of the honing stone does not occur.

Under certain quality requirements, it is necessary to hone the entire surface, the softer area and the harder area, together to the final dimension. In this case, the entire surface is honed to the finished state, with preferably less than 10 μm, particularly preferably less than 2 μm, being removed from the diameter in the softer area. The removal caused by the honing is usually 30 μm. By reducing the removal in the soft area of the surface, the smearing of the honing stone can be kept to a minimal level.

For further reducing the smearing of the honing stone, it is possible to use different honing stones for the softer area and the harder area. This may be realized for example by a double-expandable honing tool.

A further advantage obtained by the method according to the invention is that of turning grooves in the softer area, which are introduced by the pre-turning and remain at least partly after the finish-honing. Such turning grooves can be used during the operation of an internal combustion engine as lubricant pockets (reservoirs for lubricants) or for accumulating or filtering out contaminants or abrasives.

Since it is technically scarcely possible in the deeper pre-turning of the soft area to come exactly to the transition between the soft area and the hard area, it is expedient to pre-turn a small transitional area of the hard area deeper. This measure prevents any appreciable material removal from inadvertently taking place in the softer area by honing.

In many cases, a chemical after-treatment, for example by etching with sodium hydroxide solution, is required after the honing. This preferably takes place only in the hard area, so that the chemical treating agent is spared and lasts longer.

The method according to the invention is used in an expedient way for the fine machining of cylinder running surfaces. In this case, the harder area is formed by a cylinder liner, which usually consists of an aluminum alloy with a high silicon content, a cast iron alloy or a ceramic-reinforced or silicon-reinforced aluminum alloy. The softer area is in this case formed by the cast material of the cylinder crankcase, for example by an aluminum alloy AlSi9Cu3.

Preferred embodiments of the invention are explained in more detail below.

### BRIEF DESCRIPTION OF THE DRAWINGS

In the drawing:

FIG. 1 shows a detail of a cylindrical inner surface with a harder area and a softer area before machining with a turning tool,

FIG. 2 shows the detail from FIG. 1 after pre-turning, during honing, and

FIG. 3 shows an enlarged detail from FIG. 1 during finish-honing.

### DETAILED DESCRIPTION OF THE DRAWINGS

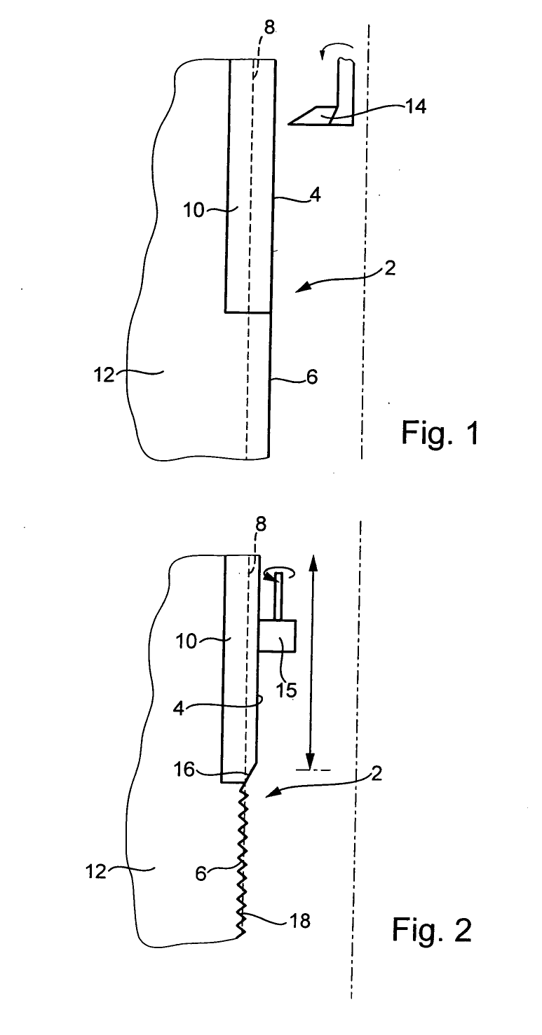

The method according to the invention is schematically illustrated with reference to FIGS. 1 to 3. In FIG. 1, a detail of a cylindrical inner surface to be machined is represented. This is the cylinder running surface 2 of a cylinder crankcase. The cylinder running surface 2 comprises a harder area 4, which is formed by a cylinder liner 10, and a softer area 6, which is formed by a cast material 12 of the cylinder crankcase.

The cylinder liner 10 consists of a hypereutectic aluminum-silicon alloy with a silicon content of about 25%. The high silicon content in the cylinder liner is responsible for the greater hardness. This is attributable to silicon crystallites, which macroscopically lead to higher hardness values (Brinell hardness) than conventional aluminum alloys. The crankcase itself is represented by the alloy AlSi9Cu3.

For machining the cylinder running surface 2, in a first working step according to FIG. 1 the cylinder running surface 2 is pre-turned with a turning tool 14. In this case, the softer area 6 is pre-turned approximately to the desired final dimension 8. However, there is a positive tolerance, for which reason the pre-turning must not go beyond the final dimension 8. In practice, the pre-turning is stopped approximately 2 μm before the final dimension 8. This means that turning grooves 18 which are produced by the pre-turning and have a peak-to-valley height of approximately 20 μm to 50 μm partly extend beyond the final dimension 8. The machining allowance in the harder area 4 is approximately 30 μm.

There is, as described in FIG. 2, a transitional area 16, in which the harder area 4 is pre-turned to almost the final dimension 8 in the same way as the softer area 6. The transitional area 16 is about 1 mm in the axial direction.

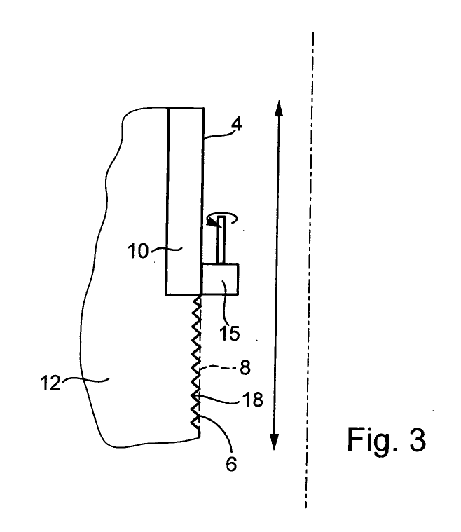

In the next working step, the area 4 is honed to approximately the final dimension (FIG. 3) with a honing tool 15, which contains honing stones that are not represented here any more specifically. Subsequently, the entire cylinder running surface 2 is machined with the honing tool 15 to the final dimension 8 (finish-honing). In this step, the honing tool 15 also moves over the softer area 6. However, this does not damage the honing stones, since the removal of material is negligible. The removal of material during the finish-honing is approximately between 2 μm and 10 μm. Since substantially only upper edges of the turning grooves 18 are removed in the soft area 6, this means an additional reduction in the removal of material in the area 6.

The turning grooves may act in an advantageous way as channels for carrying away the material particles removed during the finish-honing. During the pre-turning, it must be ensured here that the turning grooves are given a suitable depth, in order to transport away the material particles produced—depending on the material of the honing stone. The transporting away in each case takes place with the assistance of honing oil, which is discharged from the honing tool between the honing stones. In this way, the turning grooves contribute to preventing premature smearing of the honing stones.

The smearing of the honing stones, and the quality of the honed surface, is greatly dependent on the combination of the material of the surface and the material of the honing stone. The useful life of the honing stones can be further extended if different honing stones, made to match the respective surface, are used. This can be realized for example by what is known as a double-expandable honing tool. With such a honing tool it is possible for specific honing stones to be radially advanced at desired locations. The remaining honing stones consequently no longer come into contact with the surface to be machined.

For the softer area 6, it may be advantageous to use diamond-based honing stones. On the other hand, silicon-carbide-based honing stones are used with preference for the harder area 4. Further features of the honing stones are their porosity (for absorbing particles), the grain size and the grain density.

After the fine machining, the surface is treated in the area 4 with sodium hydroxide solution. As a result, aluminum on the surface is dissolved out, with hard silicon crystallites remaining. Depressions produced in this way serve during operation as lubricant pockets. Since the softer area 6 is not treated with sodium hydroxide solution, the sodium hydroxide solution lasts longer in mass production.

The area 6 does have a rougher surface than the area 4 after the fine machining. However, the area 6 is preferably underneath a bottom dead centre of a piston ring and is therefore not subject to the same requirements as the area 4 with respect to the condition of the surface. The remains of the turning grooves likewise serve as lubricant pockets, additionally filtering out dirt particles which reach the cylinder running surface from an oil chamber.

In principle, the method according to the invention can be used for all components which have local material strengthening and require particularly high-quality surfaces. This applies specifically to areas that are subjected to high loading, in particular in the field of internal combustion engines. Examples of this which may be mentioned are frictional surfaces such as cylinder running surfaces, bearings for crankshafts, camshafts or in the transmission case.

1.-7. (canceled)

8. A method for fine machining a cylindrical inner surface, in particular a cylinder running surface, which has materials of different hardnesses in the axial direction, comprising the following steps:
pre-turning of the cylindrical inner surface, with at least one softer area of the cylindrical inner surface being pre-turned to a greater diameter than at least one harder area, and
honing of at least the harder area down to the diameter level of the softer area.

9. The method as claimed in claim 8, comprising finish honing the harder area and the softer area to a final dimension.

10. The method as claimed in claim 9, wherein a radial removal of material by the finish-honing is less than 10 μm.

11. The method as claimed in claim 9, wherein the harder area and the softer area are finish-honed by different honing stones.

12. The method as claim in claim 10, wherein the harder area and the softer area are finish-honed by different honing stones.

13. The method as claimed in claim 8, wherein turning grooves or honing grooves remain in the softer area after the honing of the harder area.

14. The method as claimed in claim 9, wherein turning grooves or honing grooves remain in the softer area after the honing of the harder area.

15. The method as claimed in claim 10, wherein turning grooves or honing grooves remain in the softer area after the honing of the harder area.

16. The method as claimed in claim 11, wherein turning grooves or honing grooves remain in the softer area after the honing of the harder area.

17. The method as claimed in claim 12, wherein turning grooves or honing grooves remain in the softer area after the honing of the harder area.

18. The method as claimed in claim 8, wherein the harder area is pre-turned down to the diameter of the softer area in a transitional area between the softer area and the harder area.

19. The method as claimed in claim 9, wherein the harder area is pre-turned down to the diameter of the softer area in a transitional area between the softer area and the harder area.

20. The method as claimed in claim 10, wherein the harder area is pre-turned down to the diameter of the softer area in a transitional area between the softer area and the harder area.

21. The method as claimed in claim 11, wherein the harder area is pre-turned down to the diameter of the softer area in a transitional area between the softer area and the harder area.

22. The method as claimed in claim 12, wherein the harder area is pre-turned down to the diameter of the softer area in a transitional area between the softer area and the harder area.

23. The method as claimed in claim 13, wherein the harder area is pre-turned down to the diameter of the softer area in a transitional area between the softer area and the harder area.

24. The method as claimed in claim 8, wherein a subsequent chemical treatment of the surface takes place only in the harder area.

25. The method as claimed in claim 9, wherein a subsequent chemical treatment of the surface takes place only in the harder area.

26. The method as claimed in claim 10, wherein a subsequent chemical treatment of the surface takes place only in the harder area.

27. The method as claimed in claim 11, wherein a subsequent chemical treatment of the surface takes place only in the harder area.

28. The method as claimed in claim 12, wherein a subsequent chemical treatment of the surface takes place only in the harder area.

29. The method as claimed in claim 13, wherein a subsequent chemical treatment of the surface takes place only in the harder area.

30. The method as claimed in claim 18, wherein a subsequent chemical treatment of the surface takes place only in the harder area.

31. A method of making an engine cylinder assembly comprising:
casting a cylinder casing with a cylindrical inner surface from a material with cylinder casing hardness,
inserting a cylinder liner into the cylinder casing to line an axial portion of the casing cylindrical inner surface, said cylinder lining material having a different hardness than said cylinder casing hardness,
pre-turning of the cylindrical inner surface formed by the cylinder casing and cylinder lining with at least one softer area of the surface being pre-turned to a greater diameter than a harder area, and
honing of at least the harder area down to a diameter level of the softer area.

32. A method according to claim 31, wherein said cylinder casing material is softer than said cylinder liner material.

33. A method according to claim 32, comprising finish honing the harder area and the softer area to a final dimension.

34. A method according to claim 33, wherein a radial removal of material by the finish-honing is less than 10 μm.

35. A method according to claim 34, wherein the harder area and the softer area are finish-honed by different honing stones.

36. A method according to claim 31, wherein turning grooves or honing grooves remain in the softer area after the honing of the harder area.

37. A method according to claim 33, wherein turning grooves or honing grooves remain in the softer area after the honing of the harder area.

38. A method according to claim 32, wherein the harder area is pre-turned down to the diameter of the softer area in a transitional area between the softer area and the harder area.

39. A method according to claim 33, wherein the harder area is pre-turned down to the diameter of the softer area in a transitional area between the softer area and the harder area.

40. A method according to claim 32, wherein a subsequent chemical treatment of the surface takes place only in the harder area.
